(19) United States
(12) Patent Application Publication
(10) Pub. No.: US 2025/0277332 A1
(43) Pub. Date: Sep. 4, 2025

(54) DRYER FILTER ASSEMBLY AND METHODS FOR REMOVING LINT FROM A DRYER FILTER ASSEMBLY

(71) Applicant: GD Midea Air Conditioning Equipment Co., Ltd., Beijiao (CN)

(72) Inventors: Steven Denis Fortier, Louisville, KY (US); Zhe Ning, Louisville, KY (US)

(21) Appl. No.: 18/591,864

(22) Filed: Feb. 29, 2024

(51) Int. Cl. D06F 58/22; B01D 46/00; B01D 46/681; D06F 34/20; D06F 103/42; D06F 105/58

(52) U.S. Cl. CPC D06F 58/22; B01D 46/0004; B01D 46/681; D06F 34/20; B01D 2279/55; D06F 2103/42; D06F 2105/58

(57) ABSTRACT

A dryer filter assembly includes a body having a distal end and a proximal end and further defining a frame that receives a filter. The dryer filter assembly further includes a plurality of receptacles, with each of the distal end of the body and the proximal end of the body defining at least one of the plurality of receptacles. A plurality of containers are releasably received by the plurality of receptacles, and a sweeper mechanism is slidably coupled to the body, such that the sweeper mechanism may translate in a longitudinal direction between the distal end and the proximal end of the body. Translation of the sweeper mechanism between the distal end and the proximal end of the body forces particulate accumulated on the filter to be disposed in at least one of the plurality of containers.

### TECHNICAL FIELD

The present specification generally relates to household appliances, and more specifically, to lint filters for clothing dryers and methods of removing lint from filters.

### BACKGROUND

In conventional clothing dryers, lint collection is typically managed through a simple, removable lint screen or filter located near an air outlet of the dryer. In these dryers, users must manually clean the filter after one and/or several drying cycles to prevent lint buildup, which can impair dryer performance, increase energy consumption, and pose significant fire risks due to the flammability of lint. Furthermore, these traditional dryers do not provide users with a way to determine when the lint screen and/or filter is full. Accordingly, a need exists for a dryer filter assembly that enhances user convenience while improving dryer performance and safety.

### SUMMARY

In an embodiment, a dryer filter assembly is disclosed. The dryer filter assembly includes a body having a distal end and a proximal end and further defining a frame that receives a filter. The dryer filter assembly further includes a plurality of receptacles, with each of the distal end of the body and the proximal end of the body defining at least one of the plurality of receptacles. A plurality of containers are releasably received by the plurality of receptacles, and a sweeper mechanism is slidably coupled to the body, such that the sweeper mechanism may translate in a longitudinal direction between the distal end and the proximal end of the body. Translation of the sweeper mechanism between the distal end and the proximal end of the body forces particulate accumulated on the filter to be disposed in at least one of the plurality of containers.

In another embodiment, a dryer filter assembly is disclosed. The dryer filter assembly includes a body having a distal end and a proximal end and further defining a frame configured to receive a filter, a plurality of receptacles, with each of the distal end of the body and the proximal end of the body defining at least one of the plurality of receptacles, at least one receptacle opening formed in each of the plurality of receptacles, a plurality of containers releasably received by the plurality of receptacles, at least one container aperture formed in each of the plurality of containers, such that the at least one container aperture and the at least one receptacle opening are aligned when the plurality of containers are positioned within the plurality of receptacles, and a sweeper mechanism including a sweeper component and a translation component, the sweeper mechanism being slidably coupled to the body such that the sweeper mechanism may translate in a longitudinal direction between the distal end and the proximal end of the body. When the sweeper mechanism translates between the distal end and the proximal end of the body, the sweeper component of the sweeper mechanism contacts a surface of the filter to dislodge lint from the surface of the filter and force the lint into at least one of the plurality of containers.

In yet another embodiment, a method of removing lint from a dryer filter assembly is disclosed. The method involves positioning at least first container in a first receptacle formed on a proximal end of a body of the dryer filter assembly and a second container a second receptacle formed on a distal end of the body of the dryer filter assembly; translating a sweeper mechanism slidably engaged to a frame of the body of the dryer filter assembly between a proximal end and a distal end of the body, such that the sweeper mechanism contacts a surface of a filter disposed within the frame; dislodging lint accumulated on the surface of the filter with the sweeper mechanism; forcing, via translation of the sweeper mechanism, the dislodged lint into at least one of the first container or the second container; removing at least one of the first container or the second container from the first receptacle or the second receptacle; and disposing of the dislodged lint captured in at least one of the first container or the second container.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts a front-side view of a dryer filter assembly, according to one or more embodiments shown and described herein;

FIG. 2A depicts a perspective view of the dryer filter assembly of FIG. 1 with a sweeper mechanism in an initial position, according to one or more embodiments shown and described herein;

FIG. 2B depicts a perspective view of the dryer filter assembly of FIG. 2A with the sweeper mechanism translating during a lint removal process, according to one or more embodiments shown and described herein;

FIG. 3 depicts a partially exploded view of the dryer filter assembly of FIG. 1 including a lint collector detached from the dryer filter assembly, according to one or more embodiments shown and described herein;

FIG. 4 depicts a partially exploded view of another lint collector of the dryer filter assembly of FIG. 1, according to one or more embodiments shown and described herein;

FIG. 5 depicts a partially exploded view of another lint collector of the dryer assembly of FIG. 1, according to one or more embodiments shown and described herein;

FIG. 6 depicts a perspective view of another embodiment of the dryer filter assembly of FIG. 1, according to one or more embodiments shown and described herein; and

FIG. 7 depicts an illustrative flow diagram of a method of removing lint from the dryer filter assembly of FIG. 1, according to one or more embodiments shown and described herein.

### DETAILED DESCRIPTION

Embodiments disclosed herein relate to dryer filter assemblies and methods of removing lint from a dryer filter assembly. In these embodiments, the dryer filter assembly includes a body having a distal end and a proximal end and further defining a frame that receives a filter. The dryer filter assembly further includes a plurality of receptacles, with each of the distal end of the body and the proximal end of the body defining at least one of the plurality of receptacles. A plurality of containers are releasably received by the plurality of receptacles, and a sweeper mechanism is slidably coupled to the body, such that the sweeper mechanism may translate in a longitudinal direction between the distal end and the proximal end of the body. Translation of the sweeper mechanism between the distal end and the proximal end of the body forces particulate accumulated on the filter to be disposed in at least one of the plurality of containers. In these embodiments, the plurality of containers may allow for easy and hygienic disposal of lint, while the sweeper mechanism may ensure efficient lint removal and filter maintenance of the dryer filter assembly.

As should be appreciated, in traditional clothing dryers, lint collection is managed using a simple, removable lint screen or filter that may be manually cleaned by a user following one and/or several drying cycles in order to prevent lint buildup and mitigate fire risk due to the flammability of lint. However, the frequent manual cleaning required to maintain these traditional lint screens/filters is inconvenient and often overlooked by users, leading to increased fire risk and decreased dryer efficiency. Furthermore, these traditional lint screens/filters may be difficult to access, and may offer inconsistent lint capture during operation of the clothing dryer, which may result in the buildup of residual lint throughout the filter and/or clothing dryer and the formation of clogs.

The disclosed dryer filter assembly aims to resolve these issues by including a number of integrated lint containers formed within a body of the dryer filter assembly, which may be removed from the body to allow for easy and hygienic removal of lint from the dryer filter assembly. In these embodiments, the dryer filter assembly further includes a sweeper mechanism, which may be translated across a filter disposed within the body of the dryer filter assembly to transfer lint from the filter and into the lint containers for removal.

Embodiments of dryer filter assemblies and methods of removing lint from dryer filter assemblies will now be described in additional detail herein. The following will now describe these refrigeration systems, container assemblies, and methods in more detail with reference to the drawings and where like numbers refer to like structures.

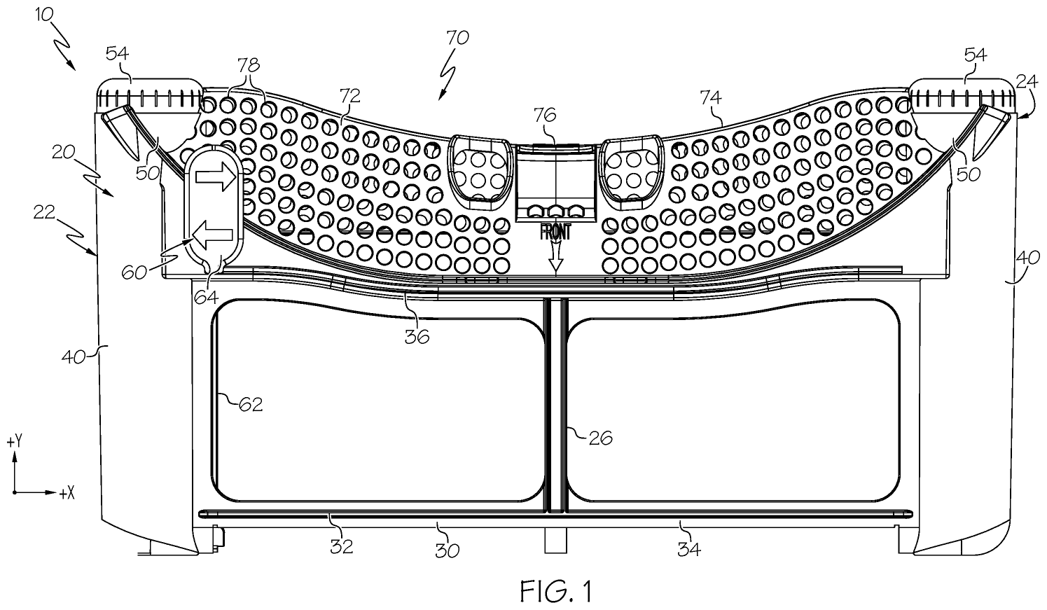

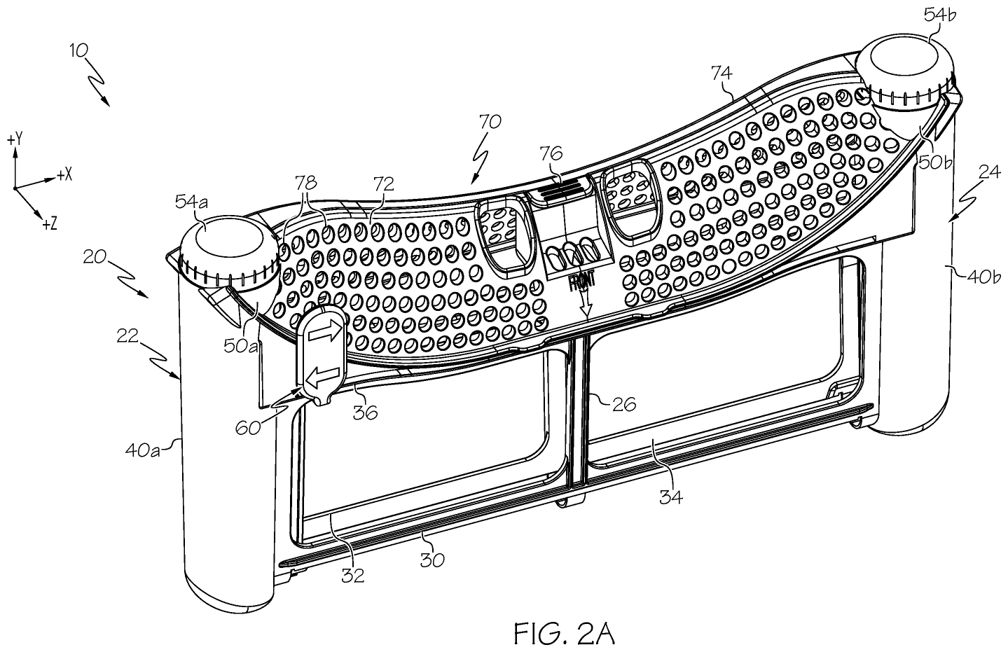

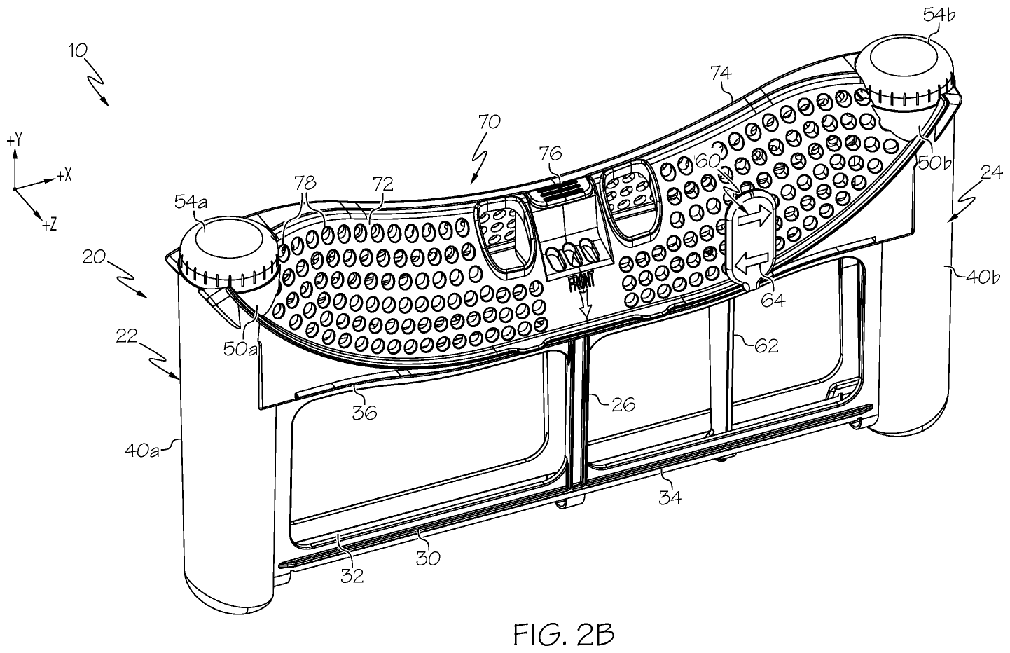

As depicted in FIGS. 1-2B, a dryer filter assembly 10 is depicted. In these embodiments, the dryer filter assembly 10 may include a body 20 having at least a proximal end 22 and a distal end 24, with the body 20 defining a frame 30 for receiving a filter, such as a dryer lint filter. As further illustrated in FIG. 1, each of the proximal end 22 and the distal end 24 of the dryer filter assembly 10 may further define a receptacle 40, which may be configured to receive at least one of a plurality of containers 50, such as a lint containers, as will be described in additional detail herein.

In the embodiments described herein, it should be appreciated that the body 20 may be formed of any durable and/or lightweight material that may withstand the high temperatures and/or humidity levels typical of a clothing dryer environment. For example, the body 20 may be formed of high temperature plastics (e.g., polycarbonate, polphenylene sulfide, polyetherimide, etc.), metal alloys (e.g., stainless steel, aluminum alloys, etc.), silicone, composite materials (e.g., fiberglass-reinforced plastics, carbon fiber composites, etc.), thermoset plastics, and/or any other similar material without departing from the scope of the present disclosure.

Referring still to FIGS. 1-2B, the dryer filter assembly 10 may further include a sweeper mechanism 60 that may be slidably coupled to the body 20 of the dryer filter assembly 10, such that the sweeper mechanism 60 may translate in a longitudinal direction (e.g., in the +/− x-direction as depicted in the coordinate axis of FIG. 1) between the proximal end 22 and the distal end 24 of the body. In these embodiments, as the sweeper mechanism 60 is translated across a length of the body 20 of the dryer filter assembly 10 (e.g., between the proximal end 22 and the distal end 24), the sweeper mechanism 60 may engage a surface of the filter (not depicted) disposed within the frame 30 of the body 20, such that contact between the sweeper mechanism 60 and the lint accumulated on the surface of the filter causes the lint to be pushed into at least one of the plurality of containers 50, as will be described in additional detail herein with reference to FIGS. 2A and 2B.

In the embodiments described herein, the body 20 may further include a partition 26, such as a central partition, which may divide the frame 30 into a first frame portion 32 and a second frame portion 34. In these embodiments, the partition 26 may provide structural rigidity and/or support to the frame 30 of the body 20, which may aid in preventing flexing and/or warping of the frame 30 that may be otherwise caused by heat within the clothing dryer and/or during removal and reinsertion of the dryer filter assembly 10. Furthermore, in some embodiments, the partition 26 may aid in evenly distributing lint across the surface of the filter, which may ensure that lint is evenly dispersed in the plurality of containers 50, as will be described in additional detail herein with reference to FIGS. 2A and 2B.

Referring still to FIGS. 1-2B, the dryer filter assembly 10 may further include a cover 70, which may be used to enclose the frame 30 and secure a filter within the frame 30. In these embodiments, the cover 70 may be formed as a two-part cover, such that the cover 70 includes a first cover portion 72 and a second cover portion 74. As illustrated in FIG. 1, the cover 70 may further include a latch 76, such as a cover latch, that may be configured to releasably and/or detachably couple the first cover portion 72 to the second cover portion 74. In these embodiments, releasing the latch 76 may allow for the first cover portion 72 to be disengaged from the second cover portion 74, such that a user may access the frame 30 of the dryer filter assembly 10 to replace a filter without needing to remove the dryer filter assembly 10 from the dryer.

As further depicted in FIGS. 1-2B, the cover 70 may further include a plurality of perforations 78. In these embodiments, the plurality of perforations 78 may allow for air to flow through the dryer filter assembly 10. For example, during operation of a clothing dryer, air may pass through the dryer filter assembly 10 to exit the clothing dryer. Accordingly, the plurality of perforations 78 may ensure that air may pass freely through the dryer filter assembly 10 during operation of the clothing dryer.

Furthermore, in the embodiments described herein, the plurality of perforations 78 may be designed to maximize a volume of lint that may be trapped within the dryer filter assembly 10 while minimizing the obstruction of air passage through the dryer filter assembly 10. For example, the plurality of perforations 78 may be sized and positioned such that the plurality of perforations 78 are small enough to capture lint within the dryer filter assembly 10 while being large enough to allow for the passage of moist air through the dryer filter assembly 10 during operation of the clothing dryer.

Referring still to FIGS. 1-2B, it should be further appreciated the size and/or positioning of the plurality of perforations 78 on the cover 70 of the dryer filter assembly 10 may aid in preventing excessive lint accumulation within the frame 30 of the dryer filter assembly 10. For example, in these embodiments, the plurality of perforations 78 may further act to limit excessive lint accumulation in any particular portion of the dryer filter assembly 10, thereby allowing for even lint distribution across the filter positioned within the frame 30 of the dryer filter assembly 10 and minimizing the risk of clogging in the clothing dryer.

Referring now to FIGS. 2A and 2B, operation of the dryer filter assembly 10 will be described in additional detail. Initially, as a drum of the clothing dryer rotates, articles (e.g., clothing or otherwise) within the clothing dryer may begin to tumble, thereby causing friction between the articles and leading to the formation of lint (e.g., via fibers being loosened and/or shed from the articles). As the clothing dryer continues its operation cycle, air is pulled into the clothing dryer from an external environment, heated, and passed through the clothing dryer. As the heated air flow passes through the clothing dryer, it may also carry lint generated by the contact between articles during the tumble process.

In these embodiments, the heated air carrying the lint is drawn through the dryer filter assembly 10 as it exits the clothing dryer. Accordingly, as the heated air passes through the dryer filter assembly 10, lint carried by the heated air is captured by the filter positioned within the frame 30 of the body 20 of the dryer filter assembly 10. Over the course of an operation cycle, lint may be accumulated on the filter of the dryer filter assembly 10, as has been described herein.

Depending on the amount of use and the types of articles being dried, the accumulation of lint on the filter over a number of operational cycles of the clothing dryer may begin to reduce the permeability and effectiveness of the dryer filter assembly 10. At this point, it may be necessary to clean the filter (e.g., dispose of the lint accumulated on the filter) in order to regain desired levels of permeability and efficiency.

Referring still to FIGS. 2A and 2B, the lint accumulated on the filter may be disposed into at least one of the plurality of containers 50 by translating the sweeper mechanism 60 across a surface of the filter, such that contact between the sweeper mechanism 60 and the filter surface causes accumulated lint to be pushed into at least one of the plurality of containers 50. In these embodiments, the frame 30 of the body 20 of the dryer filter assembly 10 may include a slot 36, which may be used to guide translation of the sweeper mechanism 60 across the surface of the filter, as will be described in additional detail herein.

In the embodiments described herein, the sweeper mechanism 60 may further include a sweeper component 62 and a translation component 64. As illustrated most clearly in FIGS. 2A and 2B, the sweeper component 62 of the sweeper mechanism 60 may be the portion of the sweeper mechanism 60 that contacts the surface of the filter, while the translation component 64 may be manipulated to translate the sweeper component 62 in the longitudinal direction (e.g., in the +/− direction as depicted in the coordinate axes of FIGS. 2A and 2B) across the surface of the filter. In the embodiments described herein, it should be appreciated that the sweeper component 62 of the sweeper mechanism 60 may include a rubber edge, a felted rubber edge, a brush (e.g., a brush including a plurality of bristles, etc.), or any other similar sweeper component that is configured to contact a surface of the filter and dislodge lint accumulated on the filter, such that the sweeper component 60 may be used to direct lint into the plurality of containers 50, as will be described herein.

Referring still to FIGS. 2A and 2B, and in the embodiments described herein, the translation component 64 of the sweeper mechanism 60 may be manually translated through the slot 36 defined in the frame 30 of the dryer filter assembly 10 such that the sweeper component 62 traverses the surface of the filter and disposes of accumulated lint. In these embodiments, the translation component 64 may be manually translatable (e.g., by grasping of a user, etc.) such that a user may be capable of pushing and/or pulling the translation component 64 to translate the sweeper mechanism 60 across the surface of the filter. Accordingly, after an operational cycle of the clothing dryer, a user may simply grasp the translation component 64 of the sweeper mechanism 60 and move the translation component 64 from the proximal end 22 of the body 20 to the distal end 24 of the body 20 (or vice versa) to dispose of lint accumulated on the filter between operational cycles of the clothing dryer.

Although not depicted, in some embodiments, the sweeper mechanism 60 may include a controller that may allow for the sweeper mechanism 60 to be automatically translated following each operational cycle of the clothing dryer. For example, in these embodiments, the translation of sweeper component 62 may be driven by an actuator, a motor, or any other similar electromechanical component, such that the sweeper mechanism 60 may be used to dispose of lint accumulated on the filter of the dryer filter assembly 10 without intervention from a user.

Referring still to FIGS. 2A and 2B, and in the embodiments described herein, the sweeper component 62 of the sweeper mechanism 60 may include a length (e.g., in the +/− y-direction (e.g., in the +/− y-direction as depicted in the coordinate axes of FIGS. 2A and 2B) that is equivalent to a height (e.g., in the +/− y-direction as depicted in the coordinate axes of FIGS. 2A and 2B) of the frame 30 of the dryer filter assembly 10. In these embodiments, by utilizing a sweeper component 62 with a length that is equivalent to a height of the frame 30, it may be possible to ensure that the sweeper component 62 of the sweeper mechanism 60 disposes of lint across a full surface area of the filter when the sweeper mechanism 60 is translated, as has been described herein.

For example, FIG. 2A depicts the sweeper mechanism 60 in an initial position, in which the sweeper mechanism 60 is adjacent the proximal end 22 of the body 20 of the dryer filter assembly 10. In these embodiments, once the filter disposed within the frame 30 of the dryer filter assembly 10 has accumulated a volume of lint, the sweeper mechanism 60 may be translated (e.g., in the + x-direction as depicted in the coordinate axes of FIGS. 2A and 2B) towards the distal end 24 of the body 20 of the dryer filter assembly 10, as is depicted in FIG. 2B. It should be appreciated that, as the sweeper mechanism 60 translates from the proximal end 22 to the distal end 24 of the body 20, lint that is accumulated on the filter may be similarly pushed towards the distal end 24 of the body 20.

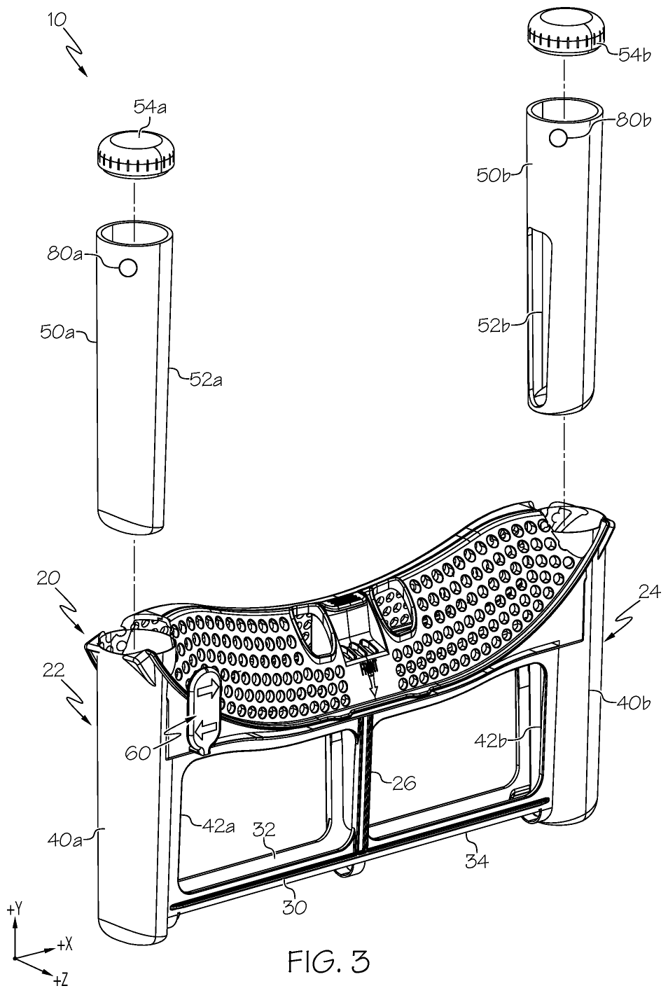

In these embodiments, the plurality of containers 50 may include a first container 50a positioned within a first receptacle 40a formed at the proximal end 22 of the body 20 and a second container 50b positioned within a second receptacle 40b formed at the distal end 24 of the body 20. Accordingly, as the sweeper mechanism 60 translates from the initial position (e.g., adjacent the proximal end 22 of the body 20) towards the distal end 24 of the body 20, the sweeper mechanism 60 may force lint accumulated on the filter into the second container 50b positioned within the second receptacle 40b, as will be described in additional detail herein with reference to FIG. 3.

Referring again to FIGS. 2A and 2B, once the sweeper mechanism 60 has translated to the distal end 24 of the body 20 and pushed any accumulated lint into the second container 50b, the sweeper mechanism 60 may remain adjacent the distal end 24 of the body 20 (e.g., in a second position or translated position) until the filter positioned within the dryer filter assembly 10 has again accumulated a volume of lint that requires removal from the filter. At this point, the sweeper mechanism 60 may be translated from the distal end 24 of the body 20 towards the proximal end 22 of the body (e.g., in the − x-direction as depicted in the coordinate axes of FIGS. 2A and 2B), such that lint accumulated on the filter is forced into the first container 50a and the sweeper mechanism returns to the initial position.

Although FIGS. 2A and 2B depict the initial position of the sweeper mechanism 60 as being adjacent the proximal end 22 of the body 20, it should be appreciated that the sweeper mechanism 60 may include any number of initial positions without departing from the scope of the present disclosure. For example, in some embodiments, the initial position of the sweeper mechanism 60 may be adjacent the distal end 24 of the body 20, such that the sweeper mechanism 60 is translated from the distal end 24 of the body 20 to the proximal end 22 of the body 20 (e.g. in the − x-direction as depicted in the coordinate axes of FIGS. 2A and 2B) when the sweeper mechanism 60 is moved from the initial position to the translated position. Furthermore, in other embodiments, the initial position of the sweeper mechanism 60 may be aligned with the partition 26 of the body 20. In these embodiments, the sweeper mechanism 60 may be translated such that lint which is accumulated on a portion of the filter corresponding to the first frame portion 32 of the frame 30 is disposed of in the first container 50a, while lint accumulated on a portion of the filter corresponding with the second frame portion 34 is disposed of in the second container 50b. For example, in these embodiments, the sweeper mechanism 60 may be translated from a central position (e.g., in alignment with partition 26) towards the distal end 24 of the body 20, such that lint accumulated in the second frame portion 34 is forced into the second container 50b. The sweeper mechanism 60 may then be translated from the distal end 24 of the body 20 towards the proximal end 22 of the body, such that lint accumulated in the first frame portion 32 is forced into the first container 50a. At this point, the sweeper mechanism 60 may then be returned to the initial position (e.g., in alignment with the partition 26).

In the embodiments described herein, it should be further appreciated that the sweeper component 62 of the sweeper mechanism 60 may be formed of any durable, flexible material that is capable of withstanding the heat and humidity of a typical clothing dryer environment while dislodging lint from a filter. For example, the sweeper component 62 of the sweeper mechanism 60 may be formed of nylon bristles, polyester bristles, silicone, thermoplastic elastomers, polytetrafluoroethylene, natural fibers, metal wires, or any other similar material without departing from the scope of the present disclosure. It should be further noted that, as described herein, the material of the sweeper component 62 may be further determined based on operational requirements of the dryer filter assembly 10 and/or the filter disposed within the frame 30 of the dryer filter assembly 10.

Referring now to FIG. 3, the plurality of containers 50 of the dryer filter assembly 10 will be described in additional detail. As noted herein, the plurality of containers 50 may be releasably received within the receptacles 40 formed at the proximal end 22 and the distal end 24 of the body 20. For example, and as described herein, the plurality of containers 50 may include the first container 50a received by the first receptacle 40a and the second container 50b received by the second receptacle 40b.

In the embodiments described herein, the receptacles 40 may be sized and/or shaped to match an exterior profile of the plurality of containers 50. For example, as depicted in FIG. 3, the plurality of containers 50 and the receptacles 40 may each have a generally tubular and/or cylindrical profile, such that the plurality of containers 50 may fit snugly within the receptacles 40 while being easily removable to dispose of lint accumulated within the plurality of containers 50. Although not depicted, in some embodiments, the receptacles 40 may further include guiding components, such as grooves and/or rails, that are configured to receive the plurality of containers 50 and ensure alignment of particular components of the plurality of containers 50 and the receptacles, as will be described in additional detail herein.

Referring still to FIG. 3, in order to allow for lint accumulated on the filter to be pushed into the plurality of containers 50 via the sweeper mechanism 60, as has been described herein, the receptacles 40 may each include a receptacle opening 42 that may be aligned with a container aperture 52 formed in each of the plurality of containers 50 when the plurality of containers 50 are positioned within the receptacles 40. For example, as depicted in FIG. 3, the first receptacle 40a may include a first receptacle opening 42a, which may be in alignment with a first container aperture 52a formed in the first container 50a. Accordingly, when the sweeper mechanism 60 translates from the distal end 24 of the body 20 towards the proximal end 22 of the body 20 (e.g., in the-x-direction as depicted in the coordinate axis of FIG. 3), the lint accumulated on the filter may pass through the first receptacle opening 42a of the first receptacle 40a and the first container aperture 52a of the first container 50a and be stored within the first container 50a prior to disposal. Similarly, the second receptacle 40b may include a second receptacle opening 42b which may be alignment with a second container aperture 52b formed in the second container 50b when the second container 50b is positioned within the second receptacle 40b. Accordingly, when the sweeper mechanism 60 translates from the proximal end 22 of the body 20 towards the distal end 24 of the body 20 (e.g., in the +x-direction as depicted in the coordinate axis of FIG. 3), lint accumulated on the filter may pass through the second receptacle opening 42b of the second receptacle 40b and the second container aperture 52b of the second container 50b and be stored within the second container 50b prior to disposal.

Although the plurality of containers 50 and the receptacles 40 depicted in FIG. 3 are illustrated as being cylindrical in shape, it should be appreciated that the plurality of containers 50 may take any shape without departing from the scope of the present disclosure. For example, in embodiments, the plurality of containers 50 may be rectangular, triangular, or any other similar shape without departing from the scope of the present disclosure. Furthermore, it should be understood that the receptacles 40 may take any shape that corresponds to the shape of the container of the plurality of containers 50 that is received by the receptacle 40. Additionally, it should be noted that, in some embodiments, each of the plurality of containers 50 may take different shapes. For example, the first container 50a may be cylindrical while the second container 50b may be rectangular. Accordingly, in these embodiments, the receptacles 40 may similarly include different shapes that correspond to the shapes of the container of the plurality of containers 50 that is received by the receptacle 40.

Referring still to FIG. 3, in these embodiments, the plurality of containers 50 may each include a cap 54 that may be releasably coupled a respective container of the plurality of containers 50. For example, as illustrated in FIG. 3, the first container 50a may include a first cap 54a while the second container 50b may include a second cap 54b. In these embodiments, the cap 54 may ensure that lint which is disposed within each of the plurality of containers 50 does not escape from the plurality of containers 50 until the plurality of containers 50 are removed from the dryer filter assembly 10 to dispose of the lint. In these embodiments, the cap 54 may be coupled to the plurality of containers 50 via any suitable releasably coupling, including a snap-fit coupling, threaded coupling, or any other similar coupling. When the plurality of containers 50 are removed from the dryer filter assembly 10, the cap 54 of each respective container of the plurality of containers 50 may be removed, such that lint accumulated within each of the plurality of containers 50 may be disposed.

Referring still to FIG. 3, in some embodiments, the dryer filter assembly 10 may further include a plurality of sensor mechanisms 80 that may be configured to monitor the accumulation of lint within the dryer filter assembly 10 and notify a user that lint within the dryer filter assembly 10 requires disposal.

In these embodiments, and as depicted in FIG. 3, the plurality of sensor mechanisms 80 may be disposed on each of the plurality of containers 50, and may be configured to monitor a volume of lint accumulated within each of the plurality of containers 50. For example, a first sensor mechanism 80a may be integrated into and/or otherwise disposed on the first container 50a, while a second sensor mechanism 80b may be integrated into and/or otherwise disposed on the second container 50b. In these embodiments, the first sensor mechanism 80a may monitor a first volume of lint contained in the first container 50a, while the second sensor mechanism 80b may monitor a second volume of lint contained in the second container 50b. In these embodiments, when the first sensor mechanism 80a determines that the first volume of lint contained in the first container 50a exceeds a threshold lint volume, or when the second sensor mechanism 80b determines that the second volume of lint contained in the second container 50b exceeds the threshold lint volume, the first and/or second sensor mechanism 80a, 80b may provide a notification to a user indicating that the first and/or second container 50a/50b require cleaning. In the embodiments described herein, the notification provided to the user may be in the form of an audible tone generated by the clothing dryer, or, in more sophisticated and/or smart clothing dryer systems, may include a mobile and/or computer notification provided to a mobile and/or computer application associated with the clothing dryer and/or dryer filter assembly 10.

Referring still to FIG. 3, in some embodiments, the plurality of sensors 80 may be further communicatively coupled to the sweeper mechanism in order to monitor (e.g., count) a number of times the sweeper mechanism 60 translates between the proximal end 22 and the distal end 24 of the body 20. In these embodiments, the plurality of sensors 80 may generate a notification to a user indicating that the plurality of containers 50 require emptying by counting a number of translations of the sweeper mechanism 60 rather than by monitoring a volume of lint within each of the plurality of containers 50. In the embodiments described herein, when the number of translations meets and/or exceeds a translation threshold, the plurality of sensors 80 may generate the notification to the user, as has been described in detail herein.

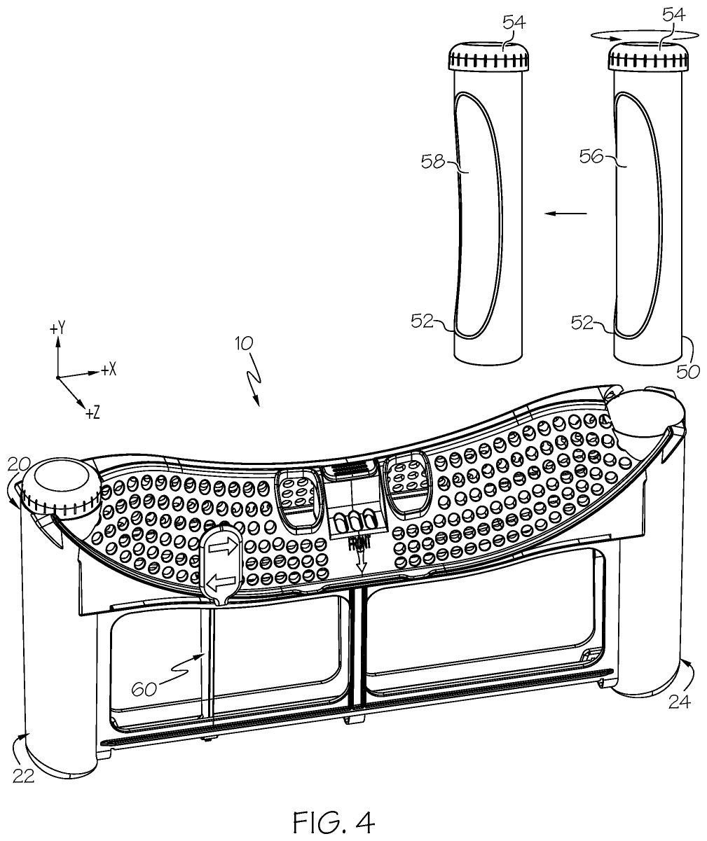

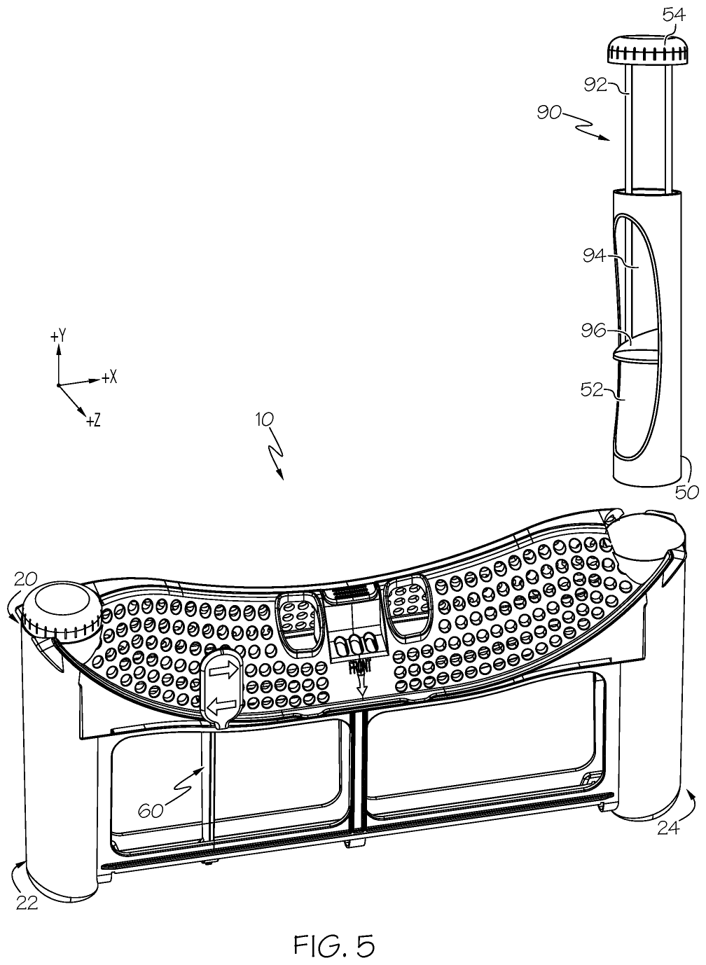

Referring now to FIGS. 4 and 5, in some embodiments, the plurality of containers 50 may include additional features that aid in retention and/or removal of lint disposed in each of the plurality of containers 50. For example, as illustrated in FIG. 4, the plurality of containers 50 may each include a canister 56. In these embodiments, each of the plurality of containers 50 may receive a canister 56 which occupies an internal volume of each of the plurality of containers 50, such that lint which is forced into each of the plurality of containers 50 is received within each respective canister 56.

Referring still to FIG. 4, in these embodiments, the canister 56 may be rotatably received within each of the plurality of containers 50. For example, the canister 56 may be sized and/or shaped such that, when the canister 56 is positioned in any one of the plurality of containers 50, the canister 56 may be capable of rotating about its lateral axis (e.g., the y-axis as depicted in FIG. 4).

As further depicted in FIG. 4, the canister 56 may include a canister aperture 58, which may be rotated into and out of alignment with the container aperture 52 of the container in which the canister 56 is positioned. Accordingly, rotating the canister 56 such that the container aperture 56 is aligned with the canister aperture 58 may allow and/or prevent lint from entering and/or exiting each of the plurality of containers 50, as will be described in additional detail herein.

For example, the canister 56 may be rotated such that the canister aperture 58 is in alignment with the container aperture 52 of the container in which the canister 56 is positioned. In these embodiments, with the canister aperture 58 and the container aperture 52 aligned, lint may be forced into the canister 56 using the sweeper mechanism 60, as has been described in detail herein with reference to FIGS. 1 and 2. However, once the canister 56 is filled with lint, the canister 56 may be rotated, such that the canister aperture 58 is misaligned with the container aperture 52, thereby preventing lint from entering the canister 56. It should be appreciated that, in these embodiments, rotating the canister 56 prior to removal of each of the plurality of containers 50 from the dryer filter assembly 10 may aid in ensuring that lint does not escape from the plurality of containers 50 during the removal process.

Referring still to FIG. 4, it should be further understood that, in these embodiments, the canister 56 may be coupled to and/or integrally formed with the cap 54 of each of the plurality of containers 50, such that rotation of the cap 54 similarly results in rotation of the canister 56, as has been described herein.

Referring now to FIG. 5, in these embodiments, each of the plurality of containers 50 may further include a plunger 90, which may be configured to aid in removing lint from each of the plurality of containers 50 once the plurality of containers 50 are removed from the dryer filter assembly 10.

In these embodiments, the plunger 90 may include a first end 92 and a second end 94, with the first end 92 being coupled to at least a portion of the cap 54 and the second end 94 including a plunger plate 96. As depicted in FIG. 5, the plunger 90 may be inserted into each of the plurality of containers 50 such that the plunger plate 96 contacts a bottom surface (e.g., floor, etc.) of the container of the plurality of containers 50 in which the plunger 90 is disposed. In these embodiments, the plunger 90 may be translatable along a lateral axis (e.g., the y-axis as depicted in FIG. 5), such that the plunger plate 96 is capable of moving in the lateral direction along a height of the container in which the plunger plate 96 is disposed.

As should be further appreciated in view of FIG. 5, lint may be received by each of the plurality of containers 50 using the sweeper mechanism 60, as has been described in detail herein with reference to FIGS. 1 and 2A-2B. In these embodiments, when lint from the filter is forced into the container of the plurality of containers 50 that includes the plunger 90, the lint may collect above the plunger plate 96. Once the container is sufficiently full (e.g., as may be determined by the plurality of sensor mechanisms 80), the container may be removed from the dryer filter assembly 10. To remove the lint from the container, the cap 54 may be pulled (e.g., in the + y-direction as depicted in the coordinate axis of FIG. 5), which may in turn cause the plunger plate 96 to traverse the container. As the plunger plate 96 moves, the plunger plate 96 may contact lint disposed above the plunger plate 96, such that the plunger plate 96 forces lint within the container to be forced out of the opening formed in the top portion of the container via the removal of the cap 54.

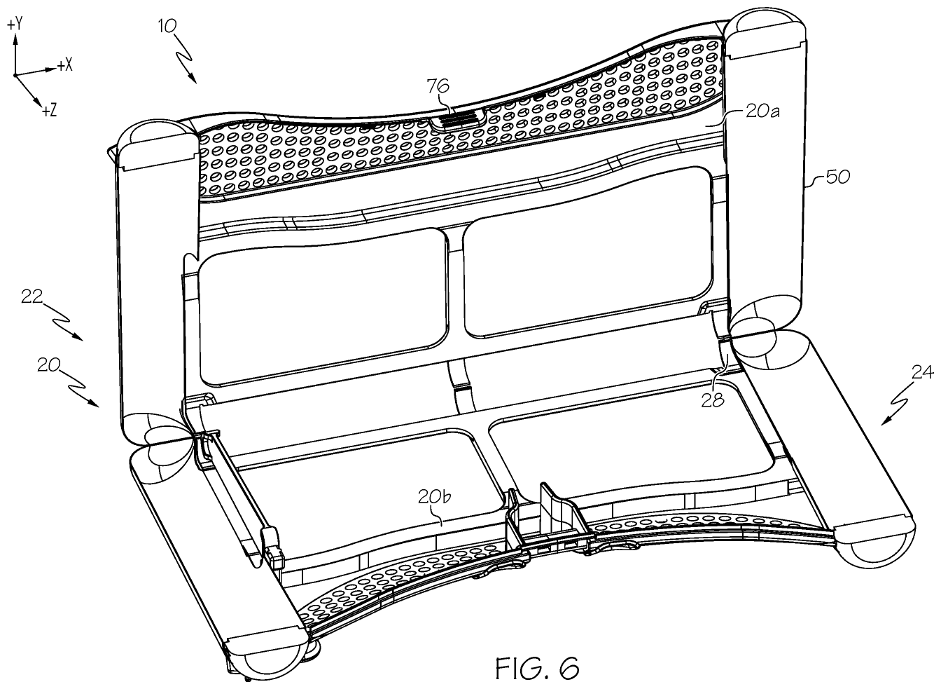

Referring now to FIG. 6, another embodiment of a dryer filter assembly 10 is depicted. In these embodiments, the body 20 of the dryer filter assembly 10 may be formed of at least two parts, such as a first body member 20a and a second body member 20b, with the first body member 20a and the second body member 20b being releasably coupled. For example, in these embodiments, the body 20 may include a hinge 28 disposed on a bottom surface of the body 20 which allows for the first body member 20a and the second body member 20b to be moved from a closed position (e.g., in which the latch 76 of the cover 70 secures the first body member 20a and the second body member 20b together) and an open position (e.g., in which the latch 76 is released such that the first body member 20a and the second body member 20b translate relative one another).

In these embodiments, the plurality of containers 50 may be fixedly attached and/or integrally coupled to the proximal end 22 and the distal end 24 of the body 20, such that the plurality of containers 50 may not be removed from the body 20. Accordingly, in these embodiments, in order to remove lint that has been accumulated within each of the plurality of containers 50 from the dryer filter assembly 10, the first and second body members 20a, 20b may be translated from the closed position to the open position, such that the lint within the plurality of containers 50 may be accessed and removed.

Although FIG. 6 depicts the body 20 of the dryer filter assembly 10 as including a hinge 28, it should be appreciated that the body 20 may include any coupling (e.g., snap fit, etc.) that may allow the first body member 20a and the second body members 20b to move relative one another without departing from the scope of the present disclosure.

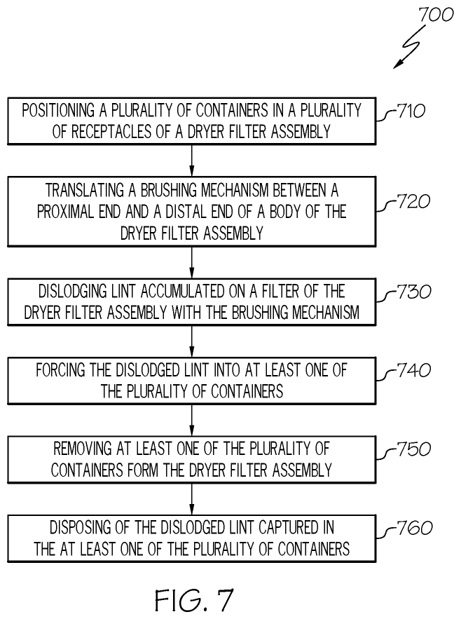

Turning now to FIG. 7, an illustrative method 700 of removing lint from a dryer filter assembly is described in additional detail. In these embodiments, the method may initially involve positioning at least a first container in a first receptacle formed on a proximal end of a body of the dryer filter assembly and a second container in a second receptacle formed on a distal end of the body of the dryer filter assembly, as is illustrated at block 710.

With the plurality of containers (e.g., first and/or second container) positioned within their respective receptacles, the method may advance to block 720, which may involve translating a sweeper mechanism between a proximal end and a distal end of the body, such that the sweeper mechanism contacts a surface of a filter disposed within a frame of the body. In these embodiments, the translation of the sweeper mechanism may further result in dislodging of lint accumulated on the surface of the filter, as depicted at block 730.

As lint is dislodged from the filter and the sweeper mechanism continues to translate, the method may proceed to block 740, which may involve forcing (e.g., via translation of sweeper mechanism) the dislodged lint into at least one of the plurality of containers (e.g., the first and/or second container). In these embodiments, once the lint is dislodged from the filter and forced into at least one of the containers, the method may proceed to block 750, which may involve removing at least one of the first or second containers from the first or second receptacle, as may be dictated based on the container that received the dislodged lint. After the appropriate container has been removed from the dryer filter assembly, the method may advance to block 760, which may involve disposing of the dislodged lint captured in the container.

As should be appreciated in view of the foregoing, a dryer filter assembly is disclosed. The dryer filter assembly includes a body having a distal end and a proximal end and further defining a frame that receives a filter. The dryer filter assembly further includes a plurality of receptacles, with each of the distal end of the body and the proximal end of the body defining at least one of the plurality of receptacles. A plurality of containers are releasably received by the plurality of receptacles, and a sweeper mechanism is slidably coupled to the body, such that the sweeper mechanism may translate in a longitudinal direction between the distal end and the proximal end of the body. Translation of the sweeper mechanism between the distal end and the proximal end of the body forces particulate accumulated on the filter to be disposed in at least one of the plurality of containers. In these embodiments, the plurality of containers may allow for easy and hygienic disposal of lint, while the sweeper mechanism may ensure efficient lint removal and filter maintenance of the dryer filter assembly.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof”' means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A dryer filter assembly comprising:
a body having a distal end and a proximal end and further defining a frame configured to receive a filter;
a plurality of receptacles, with each of the distal end of the body and the proximal end of the body defining at least one of the plurality of receptacles;
a plurality of containers releasably received by the plurality of receptacles; and
a sweeper mechanism slidably coupled to the body, such that the sweeper mechanism may translate in a longitudinal direction between the distal end and the proximal end of the body;
wherein translation of the sweeper mechanism between the distal end and the proximal end of the body forces particulate accumulated on the filter to be disposed in at least one of the plurality of containers.

2. The dryer filter assembly of claim 1, wherein the sweeper mechanism further includes a translation mechanism for manually translating the sweeper mechanism between the proximal end and the distal end of the body.

3. The dryer filter assembly of claim 1, wherein the body further include a partition that divides the frame into a first frame portion and a second frame portion.

4. The dryer filter assembly of claim 1, wherein the plurality of containers each include a container aperture.

5. The dryer filter assembly of claim 4, wherein the plurality of receptacles each include a receptacle opening.

6. The dryer filter assembly of claim 5, wherein the container aperture of each of the plurality of containers is aligned with the receptacle opening of each of the plurality of receptacles when the plurality of containers are positioned within the plurality of receptacles.

7. The dryer filter assembly of claim 1, wherein each of the plurality of containers further includes a cap releasably coupled to the plurality of containers.

8. The dryer filter assembly of claim 1, wherein the sweeper mechanism further includes a sweeper component configured to contact a surface of the filter when the sweeper mechanism translates between the proximal end and the distal end of the body.

9. The dryer filter assembly of claim 8, wherein the sweeper component has a sweeper component length that is equivalent to a frame height of the frame.

10. The dryer filter assembly of claim 1, further comprising a cover configured to enclose the frame and secure the filter within the frame.

11. The dryer filter assembly of claim 10, wherein the cover includes a first cover portion and a second cover portion, the first cover portion and the second cover portion being releasably coupled via a latch.

12. The dryer filter assembly of claim 10, wherein the cover further includes a plurality of perforations.

13. The dryer filter assembly of claim 1, further including a plurality of sensor mechanisms configured to monitor a volume of lint in each of the plurality of containers.

14. The dryer filter assembly of claim 13, wherein, when the plurality of sensor mechanisms determine that the volume of lint in at least one of the plurality of containers exceeds a threshold lint volume, the plurality of sensor mechanisms generate a notification to a user.

15. The dryer filter assembly of claim 1, further comprising a plurality of sensor mechanisms configured to monitor a number of translations of the sweeper mechanism between the proximal end and the distal end of the body.

16. The dryer filter assembly of claim 15, wherein, when the plurality of sensor mechanisms determine that the number of translations exceeds a translation threshold, the plurality of sensor mechanisms generate a notification to a user.

17. The dryer filter assembly of claim 1, wherein the frame further defines a slot configured to guide translation of the sweeper mechanism between the proximal end and the distal end of the body.

18. A dryer filter assembly comprising:
a body having a distal end and a proximal end and further defining a frame configured to receive a filter;
a plurality of receptacles, with each of the distal end of the body and the proximal end of the body defining at least one of the plurality of receptacles;
at least one receptacle opening formed in each of the plurality of receptacles;
a plurality of containers releasably received by the plurality of receptacles;
at least one container aperture formed in each of the plurality of containers, such that the at least one container aperture and the at least one receptacle opening are aligned when the plurality of containers are positioned within the plurality of receptacles; and
a sweeper mechanism including a sweeper component and a translation component, the sweeper mechanism being slidably coupled to the body such that the sweeper mechanism may translate in a longitudinal direction between the distal end and the proximal end of the body;
wherein, when the sweeper mechanism translates between the distal end and the proximal end of the body, the sweeper component of the sweeper mechanism contacts a surface of the filter to dislodge lint from the surface of the filter and force the lint into at least one of the plurality of containers.

19. The dryer filter assembly of claim 18, further including a plurality of sensor mechanisms configured to monitor a volume of lint in each of the plurality of containers.

20. A method of removing lint from a dryer filter assembly comprising:
positioning at least a first container in a first receptacle formed on a proximal end of a body of the dryer filter assembly and a second container in a second receptacle formed on a distal end of the body of the dryer filter assembly;
translating a sweeper mechanism slidably engaged to a frame of the body of the dryer filter assembly between the proximal end and the distal end of the body, such that the sweeper mechanism contacts a surface of a filter disposed within the frame;
dislodging lint accumulated on the surface of the filter with the sweeper mechanism;
forcing, via translation of the sweeper mechanism, the dislodged lint into at least one of the first container or the second container;
removing at least one of the first container or the second container from the first receptacle or the second receptacle; and
disposing of the dislodged lint captured in at least one of the first container or the second container.
